(19) United States
(12) Patent Application Publication
(10) Pub. No.: US 2025/0132518 A1
(43) Pub. Date: Apr. 24, 2025

(54) Connector Module and Connector

(71) Applicants: Tyco Electronics Holdings (Bermuda) No. 7 Limited, Hamilton (BM); Tyco Electronics (Shanghai) Co., Ltd., Shanghai (CN)

(72) Inventors: Jiwang (Arthur) Jin, Shanghai (CN); Ava Hsu, Hamilton (BM); Xingjie (Steven) GE, Shanghai (CN); Jessica Zheng, Shanghai (CN)

(73) Assignees: Tyco Electronics Holdings (Bermuda) No. 7 Limited, Hamilton (BM); Tyco Electronics (Shanghai) Co., Ltd., Shanghai (CN)

(21) Appl. No.: 18/926,044

(22) Filed: Oct. 24, 2024

(30) Foreign Application Priority Data
Oct. 24, 2023 (CN) 202311388136.X

(51) Int. Cl. H01R 13/516

(52) U.S. Cl. CPC H01R 13/516

(57) ABSTRACT

A connector module includes: 1) a first terminal module comprising a row of first terminals; 2) a second terminal module comprising a row of second terminals; and 3) a first holder, wherein the first terminal module and the second terminal module are respectively installed on the top and bottom of the first holder. The connector module further includes: 4) a third terminal module comprising a row of third terminals; 5) a fourth terminal module comprising a row of fourth terminals; and 6) a second holder, wherein the third and fourth terminal modules are respectively installed on the top and bottom of the second holder.

### CROSS-REFERENCE TO RELATED APPLICATION

This application claims the benefit of Chinese Patent Application No. CN202311388136.X filed on Oct. 24, 2023 in the State Intellectual Property Office of China, the whole disclosure of which is incorporated herein by reference.

### FIELD OF THE DISCLOSURE

The present disclosure relates to a connector module and a connector comprising the connector module.

### BACKGROUND OF THE INVENTION

In the prior art, a connector that include upper and lower ports typically include a housing and an upper connector module and a lower connector module installed in the housing. The lower connector module includes a first holder and a first terminal and a second terminal installed on the top and bottom of the first holder, respectively. The upper connector module includes a second holder and a third terminal and a fourth terminal installed on the top and bottom of the second holder, respectively.

In the prior art, the size and structure of the third and fourth terminals are different from those of the first and second terminals, which results in the size and structure of the second holder being different from the first holder. Therefore, two different sets of molds are needed to manufacture the first and second retaining bodies, increasing manufacturing costs.

In addition, in the prior art, the rear of the second holder needs to be inserted into the first holder, which increases the size of the second holder and makes the structure of the second holder very complex, which also increases manufacturing costs.

### SUMMARY OF THE INVENTION

According to an embodiment of the present disclosure, a connector module comprises: 1) a first terminal module comprising a row of first terminals and a first front molded body and a first rear molded body for holding the row of first terminals; 2) a second terminal module comprising a row of second terminals and a second front molded body and a second rear molded body for holding the row of second terminals; 3) a first holder, wherein the first terminal module and the second terminal module are respectively installed on the top and bottom of the first holder; 4) a third terminal module comprising a row of third terminals and a third front molded body and a third rear molded body for holding the row of third terminals; 5) a fourth terminal module comprising a row of fourth terminals and a fourth front molded body and a fourth rear molded body for holding the row of fourth terminals; and 6) a second holder, wherein the third and fourth front molded bodies are respectively installed on the top and bottom of the second holder to hold the front of the third and fourth terminal modules on the second holder.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a connector module according to an exemplary embodiment of the present invention when viewed from the top;

FIG. 2 shows an illustrative perspective view of a connector module according to an exemplary embodiment of the present invention when viewed from the bottom;

FIG. 3 shows a cross-sectional view of a connector module according to an exemplary embodiment of the present invention;

FIG. 4 shows an illustrative exploded view of a connector module according to an exemplary embodiment of the present invention;

FIG. 5 shows an illustrative exploded view of the lower connector module according to an exemplary embodiment of the present invention when viewed from the top;

FIG. 6 shows an illustrative exploded view of the lower connector module according to an exemplary embodiment of the present invention when viewed from the bottom;

FIG. 7 shows an illustrative exploded view of the upper connector module according to an exemplary embodiment of the present invention when viewed from the top;

FIG. 8 shows an illustrative exploded view of the upper connector module according to an exemplary embodiment of the present invention when viewed from the bottom;

FIG. 9 shows an illustrative exploded view of a connector according to an exemplary embodiment of the present invention; and

FIG. 10 shows an illustrative perspective view of a connector according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector module is provided. The connector module comprises: a first terminal module comprising a row of first terminals and a first front molded body and a first rear molded body for holding the row of first terminals; a second terminal module comprising a row of second terminals and a second front molded body and a second rear molded body for holding the row of second terminals; a first holder, wherein the first terminal module and the second terminal module are respectively installed on the top and bottom of the first holder; a third terminal module comprising a row of third terminals and a third front molded body and a third rear molded body for holding the row of third terminals; a fourth terminal module comprising a row of fourth terminals and a fourth front molded body and a fourth rear molded body for holding the row of fourth terminals; and a second holder, wherein the third and fourth front molded bodies are respectively installed on the top and bottom of the second holder to hold the front of the third and fourth terminal modules on the second holder.

According to another embodiment of the present invention, a connector is provided. The connector comprises a connector housing; and the above connector module inserted into the connector housing.

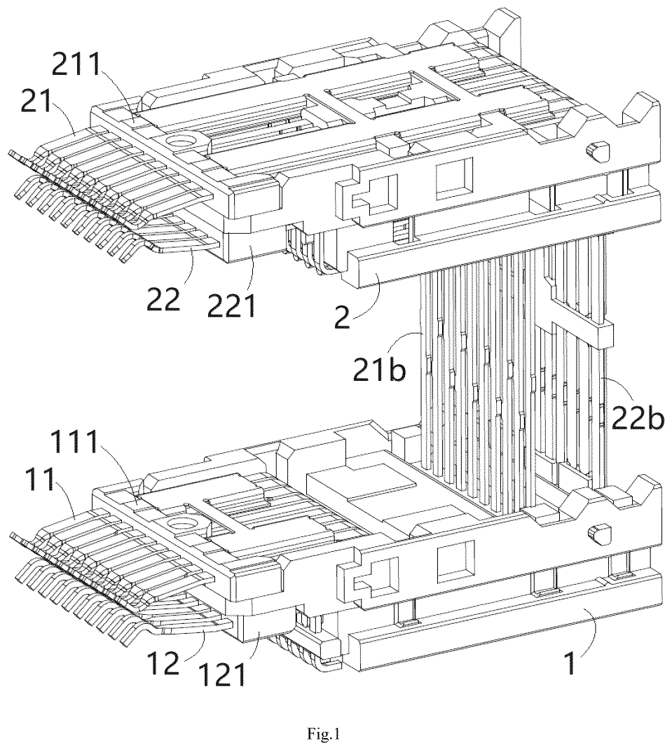

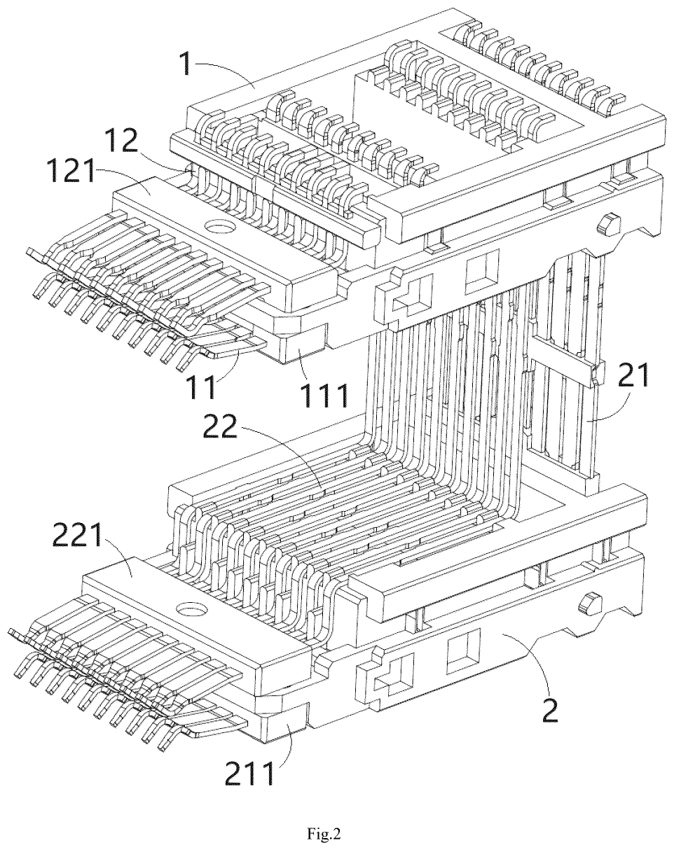

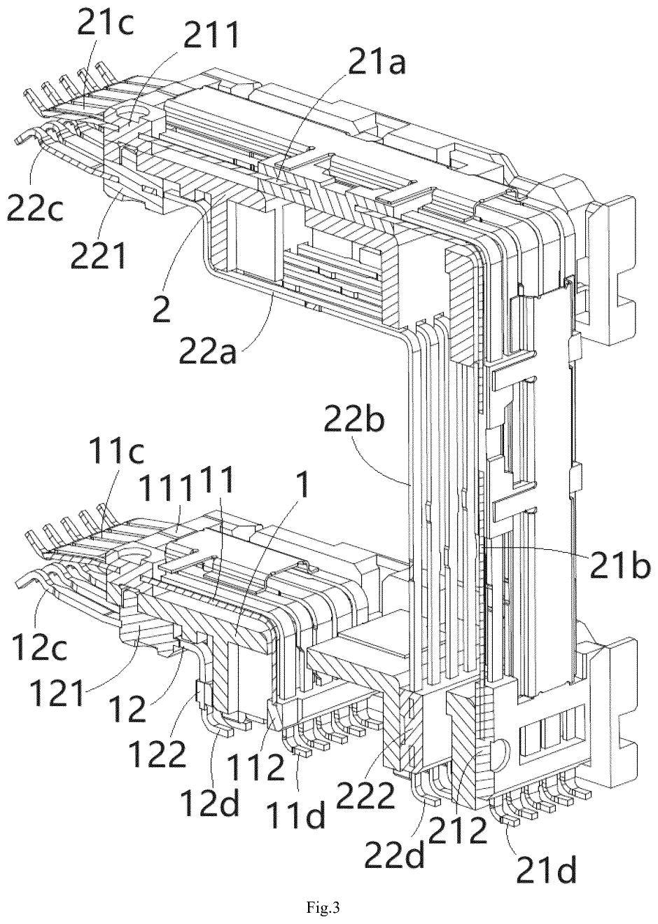

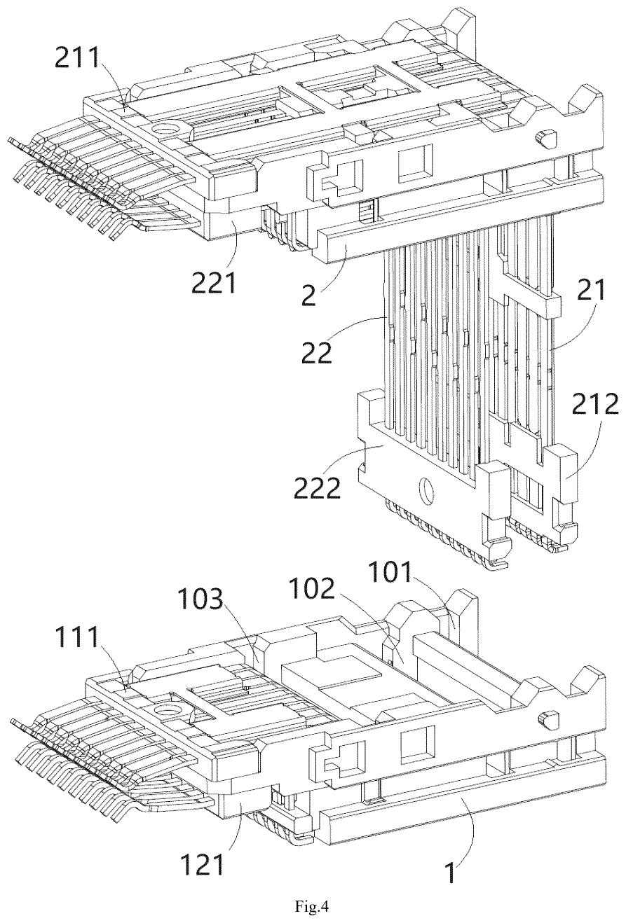

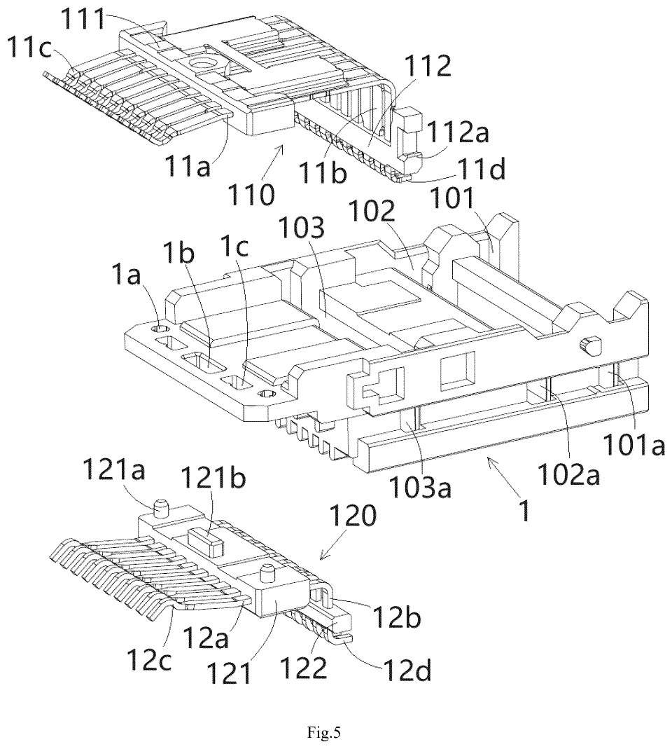

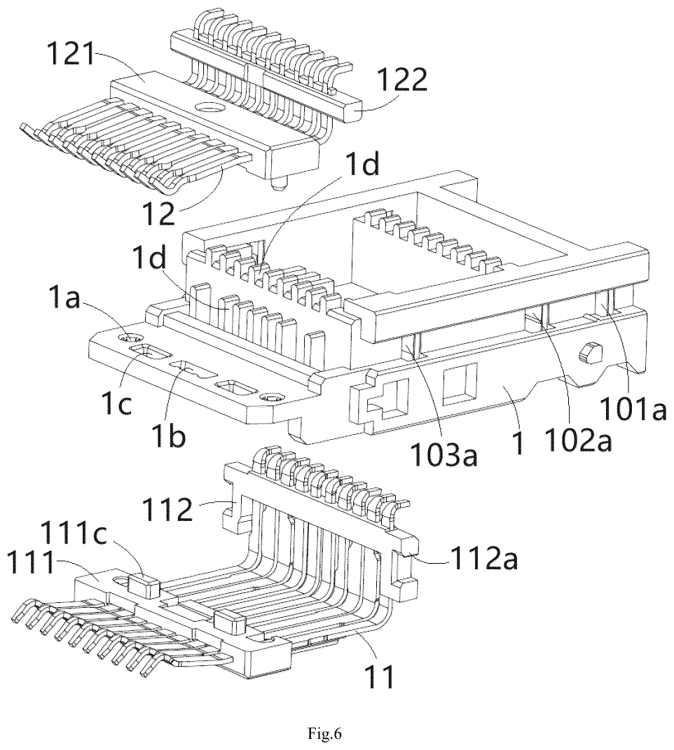

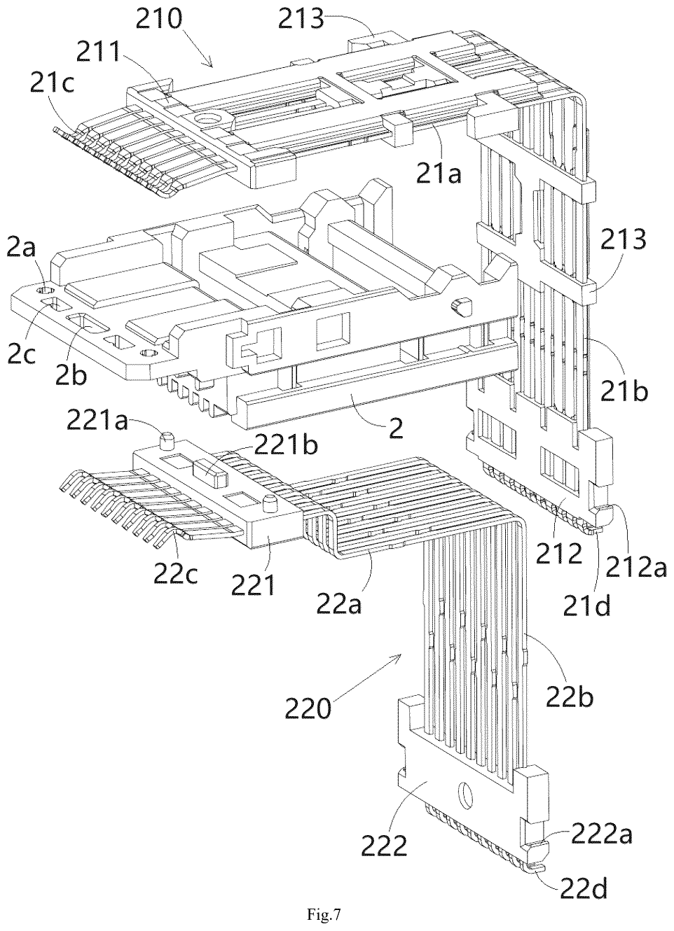

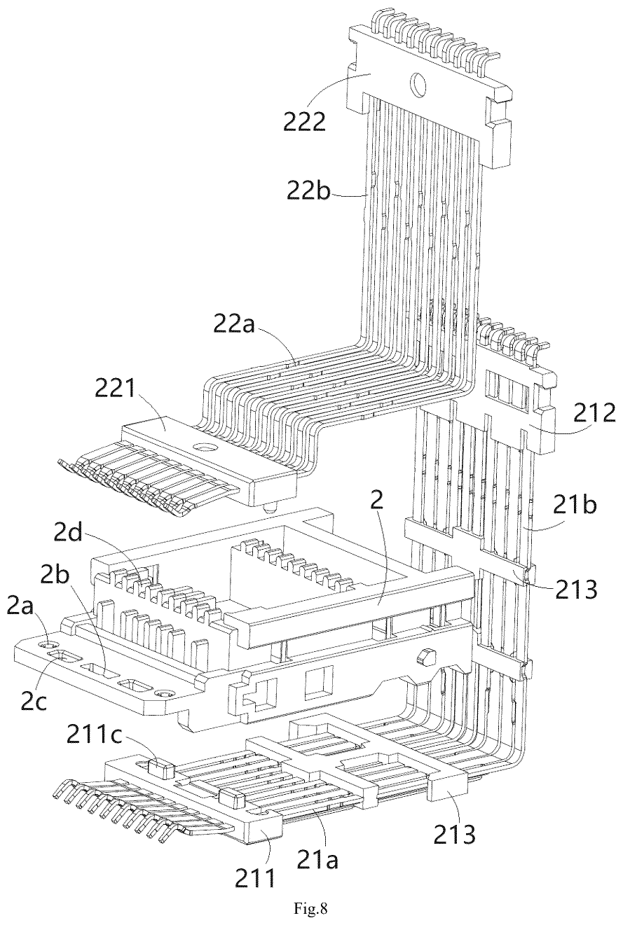

FIG. 1 shows an illustrative perspective view of a connector module according to an exemplary embodiment of the present invention when viewed from the top. FIG. 2 shows an illustrative perspective view of a connector module according to an exemplary embodiment of the present invention when viewed from the bottom. FIG. 3 shows a cross-sectional view of a connector module according to an exemplary embodiment of the present invention. FIG. 4 shows an illustrative exploded view of a connector module according to an exemplary embodiment of the present invention. FIG. 5 shows an illustrative exploded view of the lower connector module according to an exemplary embodiment of the present invention when viewed from the top. FIG. 6 shows an illustrative exploded view of the lower connector module according to an exemplary embodiment of the present invention when viewed from the bottom. FIG. 7 shows an illustrative exploded view of the upper connector module according to an exemplary embodiment of the present invention when viewed from the top. FIG. 8 shows an illustrative exploded view of the upper connector module according to an exemplary embodiment of the present invention when viewed from the bottom.

As shown in FIGS. 1-8, in an exemplary embodiment of the present invention, a connector module is disclosed. The connector module includes: a first terminal module 110, a second terminal module 120, a third terminal module 210, a fourth terminal module 220, a first holder 1, and a second holder 2. In the illustrated embodiments, the first terminal module 110 comprises a row of first terminals 11 and a first front molded body 111 and a first rear molded body 112 injected onto the row of first terminals 11. The second terminal module 120 includes a row of second terminals 12 and a second front molded body 121 and a second rear molded body 122 injected onto the row of second terminals 12. The first terminal module 110 and the second terminal module 120 are respectively installed on the top and bottom of the first holder 1. In the illustrated embodiment, the first terminal module 110, the second terminal module 120, and the first holder 1 form the lower connector module.

The third terminal module 210 includes a row of third terminals 21 and a third front molded body 211 and a third rear molded body 212 injected onto a row of third terminals 21. The fourth terminal module 220 includes a row of fourth terminals 22 and a fourth front molded body 221 and a fourth rear molded body 222 injected onto the row of fourth terminals 22. The third front molded body 211 and the fourth front molded body 221 are respectively installed on the top and bottom of the second holder 2 to keep the front of the third terminal module 210 and the fourth terminal module 220 on the second holder 2. In the illustrated embodiment, the third terminal module 210, the fourth terminal module 220, and the second holder 2 form an upper connector module.

The third rear molded body 212 and the fourth rear molded body 222 are respectively inserted into the first holder 1 to hold the rear of the third terminal module 210 and the fourth terminal module 220 on the first holder 1. Therefore, the present invention does not require the rear of the second holder 2 to be inserted into the first holder 1, thereby reducing the volume of the second holder 2 and simplifying the structure of the second holder 2, thereby reducing the manufacturing cost of the second holder 2. The first and second holders 1 and 2 are the same. This can further reduce manufacturing costs. However, please note that the present invention is not limited to the illustrated embodiments, for example, the first and second holders 1 and 2 may be different.

A first slot 101 and a second slot 102 are formed on the first holder 1, and the third rear molded body 212 and the fourth rear molded body 222 are respectively inserted into the first slot 101 and the second slot 102. A first snap slot 101a is formed on the inner wall surface of the first slot 101, and a first buckle 212a is formed on the third rear molded body 212. The first buckle 212a is engaged with the first snap slot 101a to keep the third rear molded body 212 in the first slot 101. A second snap slot 102a is formed on the inner wall surface of the second slot 102, and a second buckle 222a is formed on the fourth rear molded body 222. The second buckle 222a is engaged with the second snap slot 102a to keep the fourth rear molded body 222 in the second slot 102.

A third slot 103 is also formed on the first holder 1, and the first rear molded body 112 is inserted into the third slot 103 to hold the rear of the first terminal module 110 on the first holder 1. A third snap slot 103a is formed on the inner wall surface of the third slot 103, and a third buckle 112a is formed on the first rear molded body 112. The third buckle 112a is engaged with the third snap slot 103a to keep the first rear molded body 112 in the third slot 103.

The first holder 1 has a front end and a rear end that are opposite in its longitudinal direction, a left and right side that are opposite in its transverse direction, and a top and bottom that are opposite in its height direction. The first slot 101, second slot 102, and third slot 103 run through the first holder 1 in the height direction. The first slot 101 is located at the rear end of the first holder 1, the third slot 103 near the front end of the first holder 1, and the second slot 102 is located between the first slot 101 and the third slot 103.

The first snap slot 101a is formed on each of the left and right opposite side walls of the first slot 101, the second snap slot 102a is formed on each of the left and right opposite side walls of the second slot 102, and the third snap slot 103a is formed on each of the left and right opposite side walls of the third slot 103. The first buckle 212a is formed on each of the left and right sides of the third rear molded body 212, the second buckle 222a is formed on each of the left and right sides of the fourth rear molded body 222, and the third buckle 112a is formed on each of the left and right sides of the first rear molded body 112.

In the illustrated embodiments, a first socket 1c and a second socket 1a and 1b are formed in the front end of the first holder 1 that run through the first holder 1 along its height direction. A first post 111c is formed on the bottom surface of the first front molded body 111, and the first post 111c is inserted into the first socket 1c to maintain the front of the first terminal module 110 on the first holder 1. On the top surface of the second front molded body 121, a second post 121a and 121b is formed, and the second posts 121a and 121b are inserted into the second sockets 1a and 1b to maintain the front of the second terminal module 120 on the first holder 1. In the illustrated embodiment, the first post 111c is in an interference fit with the first socket 1c, and the second posts 121a and 121b are in an interference fit with the second sockets 1a and 1b.

The first socket 1c includes two first square sockets 1c, and the first post 111c includes two first square posts 111c corresponding to the two first square sockets 1c. The second sockets 1a and 1b include a second square socket 1b and two second circular sockets 1a, and the second posts 121a and 121b include a second square post 121b corresponding to a second square socket 1b and two second circular posts 121a corresponding to two second circular sockets 1a. The two first square sockets 1c, the second square socket 1b, and the two second circular sockets 1a are arranged in a row along the transverse direction of the first holder 1. The second square socket 1b is located between the two first square sockets 1c, and the two first square sockets 1c are located between the two second circular sockets 1a.

A third socket 2c and a fourth socket 2a and 2b are formed in the front end of the second holder 2 that run through the second holder 2 along its height direction. A third post 211c is formed on the bottom surface of the third front molded body 211, and the third post 211c is inserted into the third socket 2c to keep the front of the third terminal module 210 on the second holder 2. On the top surface of the fourth front molded body 221, fourth posts 221a and 221b are formed. The fourth posts 221a and 221b are inserted into the fourth sockets 2a and 2b to maintain the front of the fourth terminal module 220 on the second holder 2. In the illustrated embodiment, the third post 211c is in interference fit with the third socket 2c, and the fourth posts 221a and 221b are in interference fit with the fourth sockets 2a and 2b.

The third socket 2c includes two third square sockets 2c, and the third post 211c includes two third square posts 211c corresponding to the two third square sockets 2c. The fourth sockets 2a and 2b include a fourth square socket 2b and two fourth circular sockets 2a, and the fourth posts 221a and 221b include a fourth square post 221b corresponding to the fourth square socket 2b and two fourth circular posts 221a corresponding to two fourth circular sockets 2a. The two third square sockets 2c, the fourth square socket 2b, and the two fourth circular sockets 2a are arranged in a row along the transverse direction of the second holder 2. The fourth square socket 2b is located between the two third square sockets 2c, and the two third square sockets 2c are located between the two fourth circular sockets 2a.

In the illustrated embodiment, a row of first positioning slots 1d are formed on the bottom of the first holder 1 for positioning the row of second terminals 12. A row of second positioning slots 2d is formed on the bottom of the second holder 2 for positioning the row of fourth terminals 22.

The rear of the row of first terminals 11 is vertically bent downwards relative to the front of the row of first terminals 11, and the rear of the row of second terminals 12 is vertically bent downwards relative to the front of the row of second terminals 12. The first front molded body 111 is injected onto the front of the row of first terminals 11 and near the front ends 11c of the row of first terminals 11, while the first rear molded body 112 is injected onto the rear of the row of first terminals 11 and near the rear ends 11d of the row of first terminals 11. The second front molded body 121 is injected onto the front of the row of second terminals 12 and near the front ends 12c of the row of second terminals 12, while the second rear molded body 122 is injected onto the rear of the row of second terminal 12 and near the rear end 12d of the row of second terminals 12.

The rear of the row of third terminals 21 is vertically bent downwards relative to the front of the row of third terminals 21, and the rear of the row of fourth terminals 22 is vertically bent downwards relative to the front of the row of fourth terminals 22. The third front molded body 211 is injected onto the front of the row of third terminals 21 and near the front ends 21c of the row of third terminals 21, while the third rear molded body 212 is injected onto the rear of the row of third terminals 21 and near the rear ends 21d of the row of third terminals 21. The fourth front molded body 221 is injected onto the front of the row of fourth terminals 22 and close to the front ends 22c of the row of fourth terminals 22, while the fourth rear molded body 222 is injected onto the rear of the row of fourth terminals 22 and close to the rear ends 22d of the row of fourth terminals 22.

The third terminal module 210 further comprises two reinforced molded bodies 213, which are respectively injected onto the front part 21a and rear part 21b of the row of third terminals 21. The two reinforced molded bodies 213 are located between the third front molded body 211 and the third rear molded body 212.

The front ends 11c and 12c of the row of first terminals 11 and the row of second terminals 12 extend from the front end of the first holder 1 for electrical contact with first mating terminals (not shown) of a first mating connector (not shown). The front ends 21c and 22c of the row of third terminals 21 and the row of fourth terminals 22 extend from the front end of the second holder 2 for electrical contact with second mating terminals (not shown) of a second mating connector (not shown). The rear ends 11d, 12d, 21d, and 22d of the row of first terminals 11, the row of second terminals 12, the row of third terminals 21, and the row of fourth terminals 22 are exposed from the bottom of the first holder 1 and used for soldering to a circuit board (not shown).

A first guide slot 1e is formed on the outer side of each of the left and right sides of the first holder 1, which extends along the longitudinal direction of the first holder 1. The first guide slot 1e is used to fit with a first guide rib 31 on the inner surface of the side wall of the connector housing 3 to guide the first holder 1 to be inserted into the connector housing 3. However, the present invention is not limited to the illustrated embodiments. For example, the first guide rib extending along the longitudinal direction of the first holder 1 can be formed on the outer side each of the left and right sides of the first holder 1. The first guide rib is used to fit with the first guide slot on the inner surface of the side wall of the connector housing 3 to guide the first holder 1 to be inserted into the connector housing 3.

Still referring to FIGS. 1-8, in the illustrated embodiments, a second guide slot 2e is formed on the outer side of each of the left and right sides of the second holder 2 and extends along the longitudinal direction of the second holder 2. The second guide slot 2e is used to fit with the second guide rib 32 on the inner surface of the side wall of the connector housing 3 to guide the second holder 2 to be inserted into the connector housing 3. However, the present invention is not limited to the illustrated embodiments. For example, the second guide rib extending along the longitudinal direction of the second holder 2 can be formed on the outer side of each of the left and right sides of the second holder 2. The second guide rib is used to fit with the second guide slot on the inner surface of the side wall of the connector housing 3 to guide the second holder 2 to be inserted into the connector housing 3.

The second holder 2 is located directly above the first holder 1 and spaced at a predetermined distance from the first holder 1 in the height direction. The rear parts 21b and 22b of the row of third terminals 21 and the row of fourth terminals 22 extend between the rear ends of the first holder 1 and the second holder 2. The front parts 21a and 22a of the row of third terminals 21 and the row of fourth terminals 22 extend between the front and rear ends of the second holder 2.

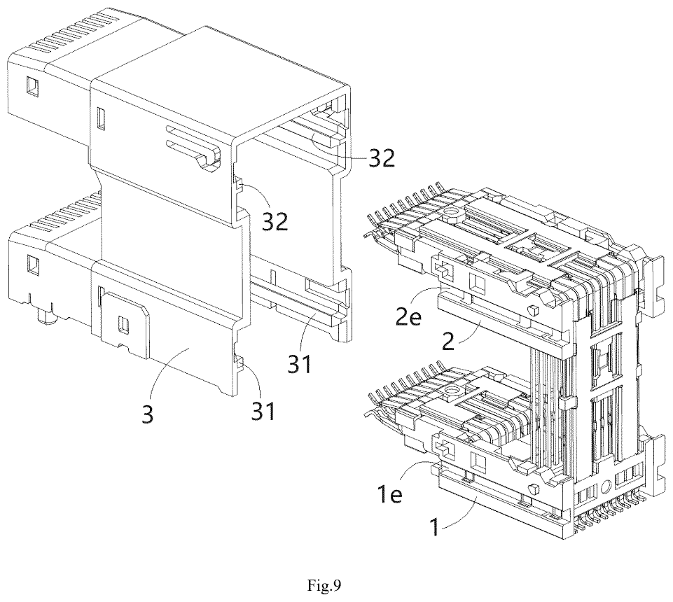

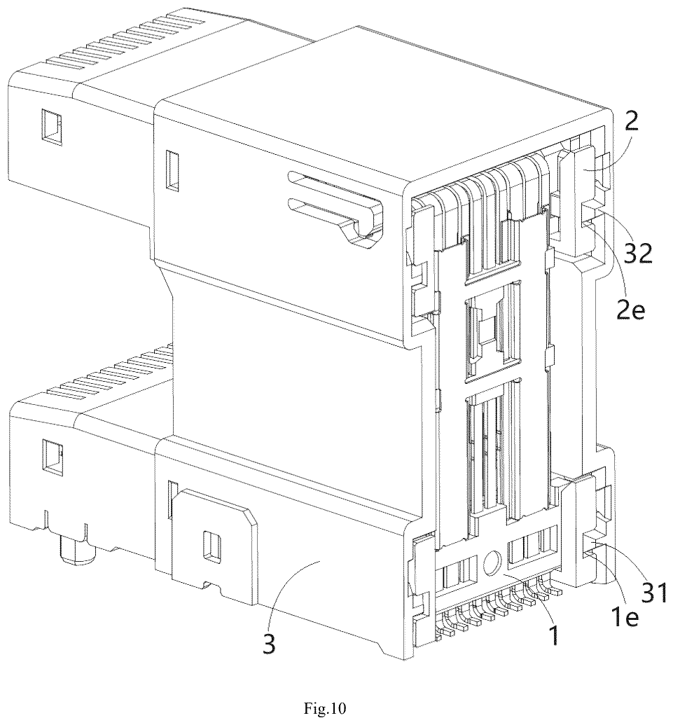

FIG. 9 shows an illustrative exploded view of a connector according to an exemplary embodiment of the present invention. FIG. 10 shows an illustrative perspective view of a connector according to an exemplary embodiment of the present invention. As shown in FIGS. 1-10, in another exemplary embodiment of the present invention, a connector is also disclosed. The connector includes: a connector housing 3 and the aforementioned connector module. The connector module is inserted into the connector housing 3.

The first guide ribs 31 are formed on the inner surfaces of the left and right side walls of the connector housing 3, respectively. The first guide rib 31 is fit with the first guide slot 1e on the first holder 1 to guide the first holder 1 to be inserted into the connector housing 3. However, the present invention is not limited to the illustrated embodiments. For example, a first guide slot can be formed on the inner surface of each of the left and right side walls of the connector housing 3, and the first guide slot is fit with the first guide rib on the first holder 1 to guide the first holder 1 to be inserted into the connector housing 3.

A second guide rib 32 is formed on the inner surface of each of the left and right side walls of the connector housing 3. The second guide rib 32 is fit with the second guide slot 2e on the second holder 2 to guide the second holder 2 to be inserted into the connector housing 3. However, the present invention is not limited to the illustrated embodiments. For example, a second guide slot can be formed on the inner surface of each of the left and right side walls of the connector housing 3, and the second guide slot is fit with the second guide rib on the second holder 2 to guide the second holder 2 to be inserted into the connector housing 3.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector module, comprising:
a first terminal module comprising a row of first terminals and a first front molded body and a first rear molded body for holding the row of first terminals;
a second terminal module comprising a row of second terminals and a second front molded body and a second rear molded body for holding the row of second terminals;
a first holder, wherein the first terminal module and the second terminal module are respectively installed on the top and bottom of the first holder;
a third terminal module comprising a row of third terminals and a third front molded body and a third rear molded body for holding the row of third terminals;
a fourth terminal module comprising a row of fourth terminals and a fourth front molded body and a fourth rear molded body for holding the row of fourth terminals; and
a second holder, wherein the third and fourth front molded bodies are respectively installed on the top and bottom of the second holder to hold the front of the third and fourth terminal modules on the second holder.

2. The connector module according to claim 1, wherein the third rear molded body and the fourth rear molded body are inserted into the first holder to hold the rear of the third terminal module and the fourth terminal module onto the first holder.

3. The connector module according to claim 1, wherein the first holder and the second holder have longitudinal, transverse, and height directions respectively, and the first holder and the second holder are arranged opposite to in the height direction and parallel to each other.

4. The connector module according to claim 1, wherein the first holder and the second holder are the same.

5. The connector module according to claim 1, wherein a first slot and a second slot are formed on the first holder, and the third rear molded body and the fourth rear molded body are respectively inserted into the first slot and the second slot.

6. The connector module according to claim 4, wherein:
a first snap slot is formed on the inner wall surface of the first slot, and a first buckle is formed on the third rear molded body, the first buckle is engaged with the first snap slot to keep the third rear molded body in the first slot; and
a second snap slot is formed on the inner wall surface of the second slot, and a second buckle is formed on the fourth rear molded body, the second buckle is engaged with the second snap slot to keep the fourth rear molded body in the second slot.

7. The connector module according to claim 4, wherein:
a third slot is also formed on the first holder, and the first rear molded body is inserted into the third slot to hold the rear of the first terminal module on the first holder; and
a third snap slot is formed on the inner wall surface of the third slot, and a third buckle is formed on the first rear molded body, the third buckle is engaged with the third snap slot to keep the first rear molded body in the third slot.

8. The connector module according to claim 7, wherein:
the first holder has a front end and a rear end that are opposite in its longitudinal direction, a left side and a right side that are opposite in its transverse direction, and a top and bottom that are opposite in its height direction; and
the first slot, the second slot and the third slot run through the first holder in the height direction, the first slot is located at the rear end of the first holder, and the third slot near the front end of the first holder, the second slot is located between the first slot and the third slot.

9. The connector module according to claim 8, wherein:
the first snap slot is formed on each of the left and right opposite sidewalls of the first slot, the second snap slot is formed on each of the left and right opposite sidewalls of the second slot, and the third snap slot is formed on each of the left and right opposite sidewalls of the third slot; and
the first buckle is formed on each of the left and right sides of the third rear molded body, the second buckle is formed on each of the left and right sides of the fourth rear molded body, and the third buckle is formed on each of the left and right sides of the first rear molded body.

10. The connector module according to claim 1, wherein:
a first socket and a second socket are formed in the front end of the first holder and run through the first holder along the height direction of the first holder;
a first post is formed on the bottom surface of the first front molded body, and the first post is inserted into the first socket to maintain the front part of the first terminal module on the first holder; and
a second post is formed on the top surface of the second front molded body, and the second post is inserted into the second socket to maintain the front part of the second terminal module on the first holder.

11. The connector module according to claim 10, wherein:
a third socket and a fourth socket are formed in the front end of the second holder and run through the second holder along the height direction of the second holder;
a third post is formed on the bottom surface of the third front molded body, and the third post is inserted into the third socket to maintain the front part of the third terminal module on the second holder; and
a fourth post is formed on the top surface of the fourth front molded body, and the fourth post is inserted into the fourth socket to maintain the front part of the fourth terminal module on the second holder.

12. The connector module according to claim 1, wherein:
a row of first positioning slots is formed on the bottom of the first holder for positioning the row of second terminals; and
a row of second positioning slots is formed on the bottom of the second holder for positioning the row of fourth terminals.

13. The connector module according to claim 1, wherein:
the rear of the row of first terminals is vertically bent downwards relative to the front of the row of first terminals, and the rear of the row of second terminals is vertically bent downwards relative to the front of the row of second terminals;
the first front molded body is injection molded onto the front of the row of first terminals and near the front end of the row of first terminals, and the first rear molded body is injection molded onto the rear of the row of first terminals and near the rear end of the row of first terminals; and
the second front molded body is injected onto the front of the row of second terminals and near the front end of the row of second terminals, and the second rear molded body is injected onto the rear of the row of second terminals and near the rear end of the row of second terminals.

14. The connector module according to claim 13, wherein:
the rear of the row of third terminals is vertically bent downwards relative to the front of the row of third terminals, and the rear of the row of fourth terminals is vertically bent downwards relative to the front of the row of fourth terminals;
the third front molded body is injected onto the front of the row of third terminals and near the front end of the row of third terminals, and the third rear molded body is injected onto the rear of the row of third terminals and near the rear end of the row of third terminals; and
the fourth front molded body is injected onto the front of the row of fourth terminals and near the front end of the row of fourth terminals, and the fourth rear molded body is injected onto the rear of the row of fourth terminals and near the rear end of the row of fourth terminals.

15. The connector module according to claim 14, wherein:
the third terminal module further comprises two reinforced molded bodies respectively injected onto the front and rear of the row of third terminals; and
the two reinforced molded bodies are located between the third front molded body and the third rear molded body.

16. The connector module according to claim 14, wherein:
the front ends of the row of first terminals and the row of second terminals extend from the front end of the first holder for electrical contact with first mating terminals of a first mating connector;
the front ends of the row of third terminals and the row of fourth terminals extend from the front end of the second holder for electrical contact with second mating terminals of a second mating connector; and
the rear ends of the row of first terminals, the row of second terminals, the row of third terminals, and the row of fourth terminals are exposed from the bottom of the first holder for soldering onto a circuit board.

17. The connector module according to claim 1, wherein a first guide slot is formed on the outer side of each of the left and right sides of the first holder and extends along the longitudinal direction of the first holder, the first guide slot is used to fit with a first guide rib on an inner side surface of a side wall of a connector housing to guide the first holder to be inserted into the connector housing.

18. The connector module according to claim 1, wherein a first guide rib is formed on the outer side of each of the left and right sides of the first holder and extends along the longitudinal direction of the first holder, the first guide rib is used to fit with a first guide slot on an inner surface of a side wall of a connector housing to guide the first holder to be inserted into the connector housing.

19. The connector module according to claim 17, wherein a second guide slot is formed on the outer side of each of the left and right sides of the second holder and extends along the longitudinal direction of the second holder, the second guide slot is used to fit with a second guide rib on an inner side surface of a side wall of a connector housing to guide the second holder to be inserted into the connector housing.

20. The connector module according to claim 17, wherein a second guide rib is formed on the outer side of each of the left and right sides of the second holder and extends along the longitudinal direction of the second holder, the second guide rib is used to fit with a second guide slot on an inner surface of a side wall of a connector housing to guide the second holder to be inserted into the connector housing.

21. The connector module according to claim 1, wherein:
the second holder is located directly above the first holder and spaced by a predetermined distance from the first holder in the height direction;
the rear parts of the row of third terminals and the row of fourth terminals extend between the rear ends of the first holder and the second holder; and
the front parts of the row of third terminals and the row of fourth terminals extend between the rear ends of the first holder and the second holder.

22. A connector, comprising:
a connector housing; and
the connector module as claimed in claim 1 inserted into the connector housing.
